(19) United States
(12) Patent Application Publication
(10) Pub. No.: US 2014/0333252 A1
(43) Pub. Date: Nov. 13, 2014

(54) ELECTRONIC SUSPENSION AND NEAR-FIELD MAGNETIC RESONANCE SYSTEM FOR SMART PHONE AND TABLET DEVICES

(71) Applicant: ANDREW RAPONI, LOS ANGELES, CA (US)

(72) Inventor: ANDREW RAPONI, LOS ANGELES, CA (US)

(21) Appl. No.: 13/890,237

(22) Filed: May 8, 2013

(51) Int. Cl. H02J 7/02

(52) U.S. Cl. CPC H02J 7/025
USPC 320/108

(57) ABSTRACT

An Electromagnetic Suspension and Near-Field Magnetic Resonance System for Smart Phones and Tablet Devices includes a Electromagnetic Suspension and Near-Field Magnetic Resonance Base Unit, a Case for a smartphone or tablet housing at least one reciprocating magnet.

### FIELD OF THE INVENTION

The present invention is in the area of electronics, and more particularly pertains to a system which simultaneously, or alternatively charges the batteries of a tablet device or smartphone wirelessly while suspending said device(s) through electromagnetic suspending mechanisms incorporating magnetic levitation technology.

### BACKGROUND

The smartphone is quickly transitioning from the category of luxury device or gadget to the distinction of becoming a household appliance or personal item de rigeur. Just as the desktop computer transmuted its prevailing use of being solely used for video games and word processing to becoming arguably more important than the dishwasher or the stove, the smart phone is inexorably following suit to becoming a global phenomenon.

Bringing to bear its capabilities of communicating by cell phone, surfing the web, or operating various apps, many people would be rendered helpless without their smartphones. However, all those functions and capabilities come at a cost: power. Today, the single biggest impediment to smart phone technology is not processing power, which has heretofore kept pace with Moore's law, but battery power. As such, many people complain about having to constantly recharge their devices.

Therefore, what is needed in the marketplace is a system which powers smartphones or tablet devices in a sleek, and conspicuous fashion wirelessly.

### SUMMARY

In general, in a first aspect, the Electromagnetic Suspension and Near-Field Magnetic Resonance System for Smart Phones and Tablet Devices features a Electromagnetic Suspension and Near-Field Magnetic Resonance Base Unit, and a Case for a smartphone or tablet housing at least one reciprocating magnet.

The features and advantages described in this summary and the following detailed description are not all-inclusive. Many additional features and advantages will be apparent to one of ordinary skill in the art in view of the drawings, specification, and claims thereof.

### BRIEF DESCRIPTION OF THE DRAWING FIGURES

FIG. 1 is a perspective of an embodiment.

FIG. 2 is a perspective view of an embodiment.

FIG. 3 is a perspective view of an embodiment.

FIG. 4 is a perspective view of an embodiment.

FIG. 5 is a perspective view of an embodiment.

FIG. 6 is a perspective view of an embodiment.

FIG. 7 is a perspective view of an embodiment.

FIG. 8 is a perspective view of an embodiment.

FIG. 9 is a perspective view of an embodiment.

FIG. 10 is a perspective view of an embodiment.

FIG. 11 is a perspective view of an embodiment.

FIG. 12 is a perspective view of an embodiment.

FIG. 13 is a perspective view of an embodiment.

FIG. 14 is an exploded view of an embodiment.

FIG. 15 is a perspective view of an embodiment.

FIG. 16 is a perspective view of an embodiment.

FIG. 17 is a perspective view of an embodiment.

### DETAILED DESCRIPTION

Various embodiments of the Electromagnetic Suspension and Near-Field Magnetic Resonance System for Smart Phones and Tablet Devices are provided below.

For the purposes of the present Description, it should be understood that a smartphone is any device that is enabled to send and receive communication through various cell phone towers, and is capable of integrating an operating system such as iOS or Android. Moreover, it should also be understood that other devices may also be used in lieu of smartphones or tablet devices. Implementations of embodiments may include “smart-watches”, laptop computers, external hard drives, etc. To the extent they are able to safely work with a plurality of electromagnets either integrated internally or externally, the embodiments may alternatively further encompass those devices.

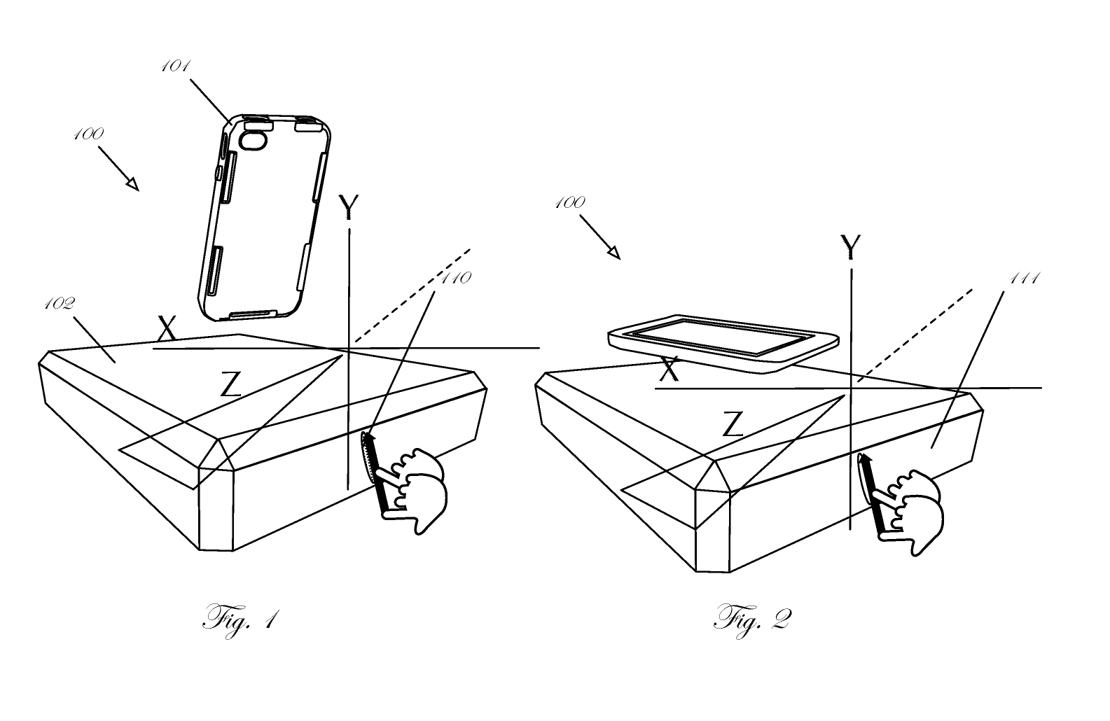

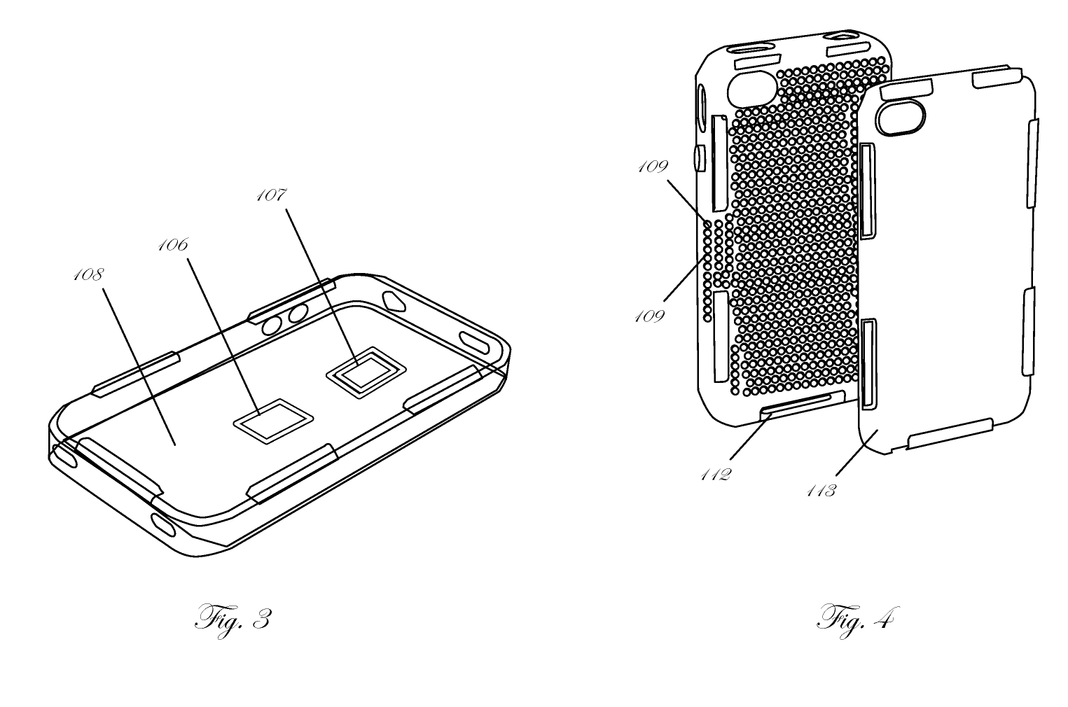

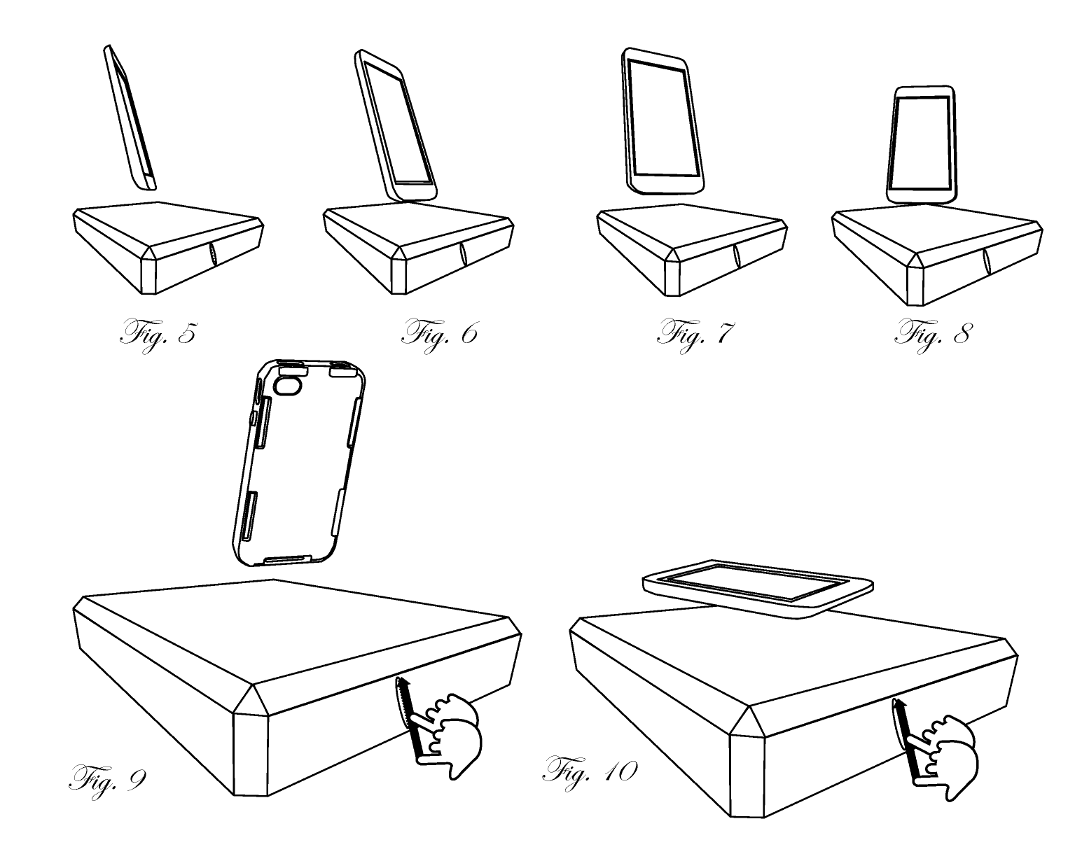

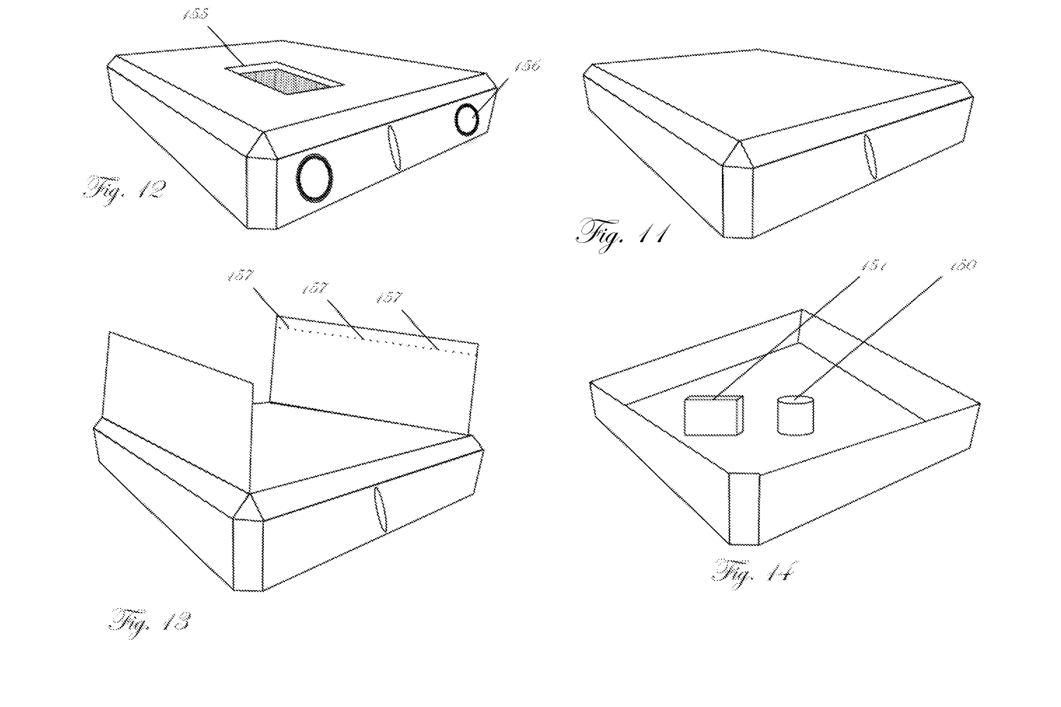

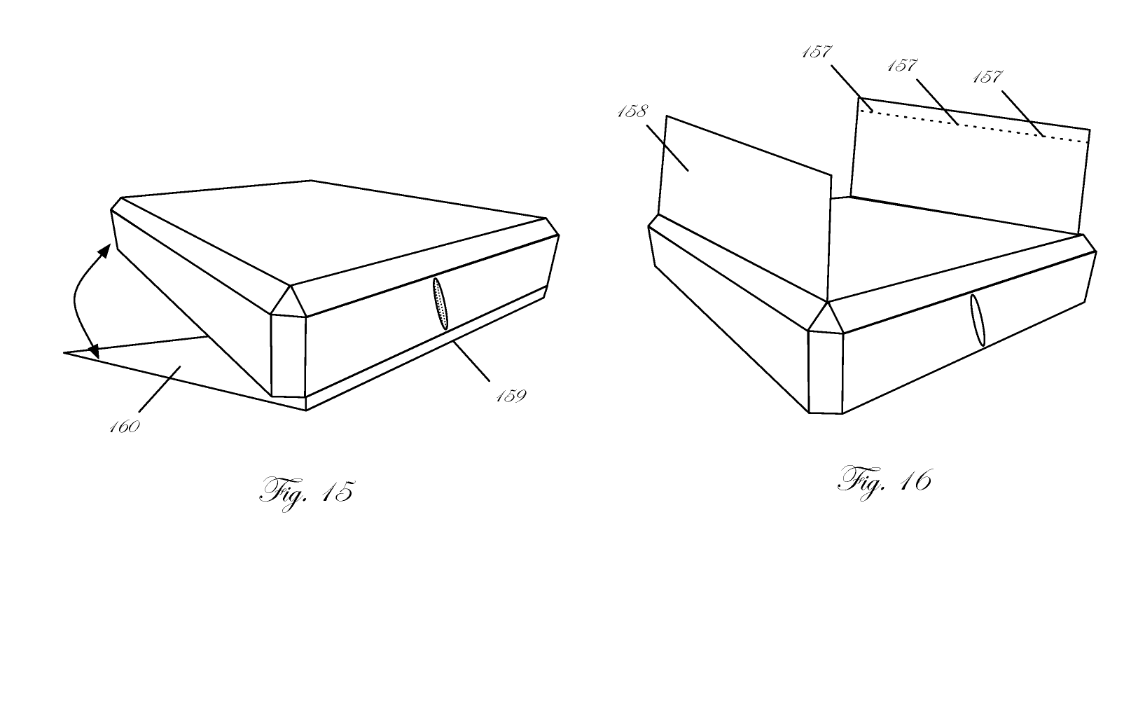

FIG. 1 illustrates that the Electromagnetic Suspension and Near-Field Magnetic Resonance System for Smart Phones and Tablet Devices 100 includes an Electromagnetic Suspension and Near-Field Magnetic Resonance Base Unit 101, and a Case for a smartphone or tablet housing at least one reciprocating magnet 102.

It should be noted here that in various implementations of an embodiment, the Electromagnetic Suspension and Near-Field Magnetic Resonance System for Smart Phones and Tablet Devices may not require the use of a case. In those embodiments, many of the operable components may be designed into the smartphone or tablet device by the OEM. For instance, the electromagnets may be internally housed within the smartphone or tablet device, which may be safely compartmentalized from the internal components through the use of a Mu Metal sheath.

The Electromagnetic Suspension and Near-Field Magnetic Resonance Base Unit 101 is used for the purpose of wirelessly emitting a charge to a tablet or smartphone device employing Near Field Magnetic Resonance power transmission and for suspending the tablet or smartphone device through use of electromagnets. The base unit is capable of emitting power to the compatible device up to one meter, which is often described or termed the “Near-Field”. The diameter of the Near-Field has been observed to be several times the aggregate size of the operative devices (i.e. the base and/or smartphone/tablet devices).

FIG. 1 illustrates that in one embodiment, the Electromagnetic Suspension and Near-Field Magnetic Resonance Base Unit 101 has a first planar surface 103. The Electromagnetic Suspension and Near-Field Magnetic Resonance Base Unit is operatively disposed underneath the smartphone or tablet device.

The Electromagnetic Suspension and Near-Field Magnetic Resonance Base Unit, in one embodiment incorporate a Groove 125 and a sensor. In operation, a user may alternatively move their finger up or down to position or suspend the device at various angles and is used for the purpose of enabling the base unit to tilt the smart phone or tablet into either an upright position at a predetermined angle or at a prostrate position.

Implementations of an embodiment may include a means for emitting a hydraulic sound, which indicates to the user that the tablet or smartphone is to be raised into an upright suspension position. Furthermore, the base unit may also emit a locking sound indicating to the user that the device is in abeyance until the user elects to change its position. These noises or sounds may emanate from a speaker 156 located within the base unit.

FIG. 12 illustrates that in one embodiment, the base unit may further comprise an inset 155 on the first planar surface. The inset is used to secure the smartphone or tablet when not in operation. In various implementations of an embodiment, the base unit may further comprise additional peripheral connectors (eg. Usb, firewire, Thunderbolt, etc.) to interact with additional devices.

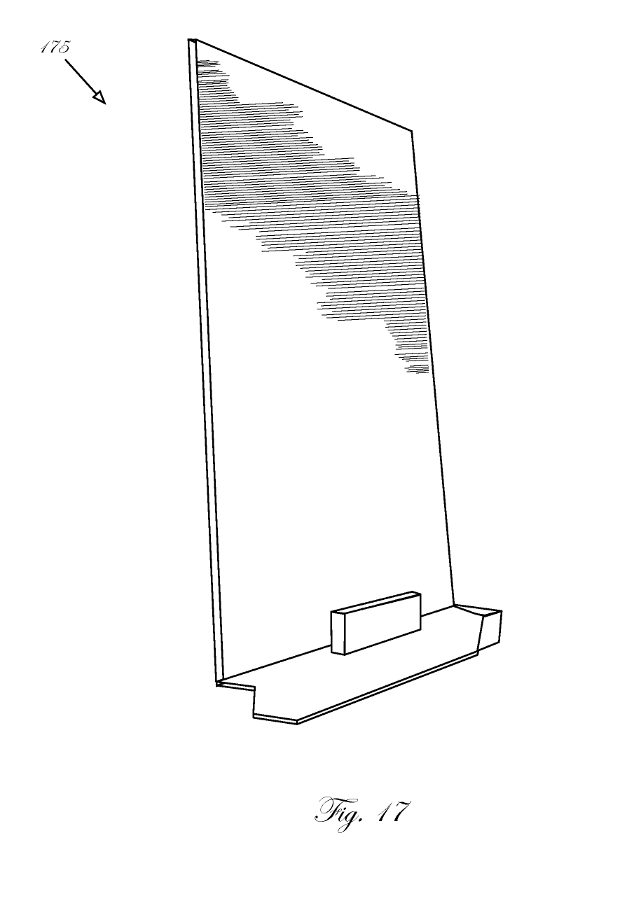

FIG. 14 illustrates that in one embodiment, the base unit may alternately include a rechargeable battery 150. Also illustrated are proximity sensors 151. FIG. 15 illustrates that the base unit may further incorporate a tilting feature whereby the base unit is lifted at an angle through the combination of a hinge 159, and a stabilizing member 160. The stabilizing member is affixed to the base unit through the hinge.

In various implementations of an embodiment, the base unit may comprise a plurality (or at least one) of base unit electromagnets. Each base unit electromagnet is enabled to be independently controllable by the base unit.

FIG. 13 illustrates that in one implementation of an embodiment, a series of light sensors 157 may be embedded in a plurality of vertical positioning walls. The light sensors detect the vertical positioning, or the height at which the case is suspended. The light sensors are in communication with the central processing unit of the base unit, and the feedback mechanism between the light sensors and the cpu enable the vertical positioning of the case. Furthermore, the proximity sensors in the base enable for the positioning of the case along the X Axis.

FIG. 4 illustrates that the case may comprise a plurality of electromagnets 109, which are sheathed in a magnetic shield 113 which may be comprised of Mu Metal. Each of the electromagnets, in one embodiment, may be fully controllable and in communication with the base unit so as to determine their precise positioning along the x-y-z axis in 3D space as illustrated in FIG. 1-2. Furthermore, the electromagnets may be smaller in order to impart increased granularity to the exact positioning thereof in 3D space.

It should be noted here that in various implementations of an embodiment, the base unit may utilize superconductors comprised of graphene, which has been shown to generate greater control over suspended objects. The use of graphene may impart greater flexibility and features in various embodiments.

The Case for a smartphone or tablet housing at least one reciprocating magnet 102 is used for the purpose of accepting a power supply from the base unit in order to form a channel for the Near Field Magnetic Resonating Base Unit. The case is sized to retain the smartphone or tablet device. In various implementations of an embodiment, the case may be made of a neoprene material to be used as an exoskeleton thus protecting the device from various abrasions, and other hard impact. Alternatively, the case may be made of other suitable materials.

In one embodiment, the Case for a smartphone or tablet housing at least one reciprocating magnet 102 has a Near-Field Magnetic Resonator Circuit 107. Also, the Case for a smartphone or tablet housing at least one reciprocating magnet is in communication with the base unit's antenna. Moreover, in various implementations of an embodiment, the Case for a smartphone or tablet housing at least one reciprocating magnet further comprises a port 112 such that a user may be able to power the device when not using the embodiments described herein.

In one implementation of an embodiment, the case is made of either a translucent or transparent material for the purpose of allowing it to retrofit upon an existing case the user is already using with the smartphone. To accommodate the retrofit, the case is sized accordingly in order to house the existing case.

FIG. 17 illustrates that in one embodiment, a slide-on case 175 is used in conjunction with a smartphone. This case is affixed to the smartphone via USB connection or similar docking connection.

The base unit may be in communication with the case, or in some embodiments, the cell phone or tablet device itself through various means including, but not limited to wifi, Bluetooth, etc. Moreover, these signals may be in communication with a third device (or more) such as a desktop computer, which may enable the synchronization of devices. These signals may be multiplexed between each other in various embodiments.

In one instance, the base unit may be in communication with the internal gyroscope of the smartphone or tablet to determine the exact positioning of the case. It may be possible to activate the gyroscope with an app to enable the syncing of information, media, as well as to control the base unit with various presets regarding music to be played, as well as the exact angle and positioning of the case in 3D space.

In addition, in various implementations of an embodiment, the base unit and the case may be in communication with each other through an infra-red transmitter-receiver based in respective devices. Furthermore, the base may include independently controlled electromagnetic coils which operate to stabilize the smartphone or tablet device.

It will be apparent to the skilled artisan that there are numerous changes that may be made in embodiments described herein without departing from the spirit and scope of those embodiments. As such, the embodiments taught herein by specific examples are limited only by the scope of the claims that follow.

What is claimed is:

1. An Electromagnetic Suspension and Near-Field Magnetic Resonance System for Smart Phones and Tablet Devices comprising:
an Electromagnetic Suspension and Near-Field Magnetic Resonance Base Unit having a first planar surface for the purpose of wirelessly emitting charge to a tablet or smartphone device employing Near Field Magnetic Resonance power transmission and for suspending the tablet or smartphone device through use of electromagnets, and a Case for a smartphone or tablet housing at least one reciprocating magnet having a Near-Field Magnetic Resonator Circuit for the purpose of accepting a power supply from the base unit in order to form a channel for the Near Field Magnetic Resonating Base Unit;
the Electromagnetic Suspension and Near-Field Magnetic Resonance Base Unit is disposed underneath the smartphone or tablet device;
the Case for a smartphone or tablet housing at least one reciprocating magnet is in communication with the base unit's antenna.

2. The Electromagnetic Suspension and Near-Field Magnetic Resonance System for Smart Phones and Tablet Devices of claim 1 wherein the Electromagnetic Suspension and Near-Field Magnetic Resonance Base Unit comprises a Groove having a sensor for the purpose of enabling the base unit to tilt the smart phone or tablet into either an upright position at a predetermined angle or at a prostrate position.

3. The Electromagnetic Suspension and Near-Field Magnetic Resonance System for Smart Phones and Tablet Devices of claim 1 wherein the Case for a smartphone or tablet housing at least one reciprocating magnet having a Near-Field Magnetic Resonator Circuit.
